(19) United States
(12) Patent Application Publication
(10) Pub. No.: US 2026/0334739 A1
(43) Pub. Date: Oct. 29, 2026

(54) SYSTEM FOR DEBRIS REMOVAL BY CONCURRENT AIRFLOW AND SUCTION

(71) Applicant: Blue Origin Manufacturing, LLC, Huntsville, AL (US)

(72) Inventor: Keil Anderson, Seattle, WA (US)

(21) Appl. No.: 19/192,078

(22) Filed: Apr. 28, 2025

(51) Int. Cl. A47L 9/08; A47L 7/04; A47L 9/12; A47L 9/28; B08B 5/02; B08B 5/04

(52) U.S. Cl. CPC A47L 9/08; A47L 7/04; A47L 9/12; A47L 9/2821; A47L 9/2836; B08B 5/02; B08B 5/04

(57) ABSTRACT

A cleaning apparatus is provided for efficient removal of foreign object debris (FOD) from surfaces while minimizing air turbulence and FOD dispersion. The apparatus includes a vacuum system that generates a negative pressure flow at a nozzle assembly to remove FOD. The vacuum system produces an exhaust, a portion of which is redirected through an exhaust outlet positioned at the nozzle assembly. The redirected exhaust forms a pressurized air stream that is oriented to dislodge FOD and direct it toward the negative pressure flow. The negative pressure flow and pressurized air stream are balanced to maintain a net negative pressure at the nozzle assembly, ensuring that FOD is effectively drawn into the vacuum portion. This configuration enhances cleaning efficiency in controlled environments such as cleanrooms, aerospace applications, and confined spaces by reducing uncontrolled FOD dispersion.

### BACKGROUND

Foreign Object Debris (FOD) and particulate contamination present significant challenges in controlled environments, such as aerospace manufacturing, cleanrooms, and confined spaces requiring stringent contamination control. Traditional vacuum systems, while effective at collecting debris, rely solely on negative pressure, which can be insufficient for removing particles that adhere to surfaces due to static, moisture, or other bonding forces. Furthermore, vacuum systems create substantial disturbances in surrounding air columns, which can redistribute FOD into previously cleaned areas, reducing overall cleaning efficiency.

Alternatively, high-velocity air-based cleaning solutions, such as air guns, air knives, and leaf blowers, excel at dislodging contaminants but fail to contain them, allowing particulate matter to spread freely throughout the environment.

An improved cleaning solution should allow for localized, targeted particulate removal while reducing the spread of FOD into already cleaned areas. Additionally, it should be suitable for use in confined spaces without introducing chemical agents or asphyxiation risks. Such a system would enhance precision cleaning and improve operational efficiency in environments such as aerospace maintenance, tank cleaning, and other high-purity industries.

### SUMMARY

Embodiments of a cleaning apparatus designed to efficiently remove foreign object debris (FOD) from surfaces while minimizing the risk of debris dispersion are described herein. The apparatus includes a vacuum system that generates a negative pressure flow at a nozzle assembly, drawing in FOD. The vacuum system also produces an exhaust, which is redirected through an exhaust outlet positioned at the nozzle assembly. This redirected exhaust creates a pressurized air stream that is strategically directed to dislodge FOD and guide it toward the negative pressure flow. The system is configured to balance the negative pressure flow and the pressurized air stream, ensuring a net negative pressure at the nozzle assembly. This balance enhances FOD capture while reducing uncontrolled debris movement, making the apparatus particularly useful in controlled environments such as aerospace applications, cleanrooms, and confined spaces.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a block diagram of a recirculating pressurized air loop for removing FOD from a surface, according to some embodiments.

FIG. 2 is a side view cross-section of a nozzle assembly for a recirculating pressurized air loop, according to some embodiments.

FIG. 3 is a perspective view of a nozzle assembly for a recirculating pressurized air loop, according to some embodiments.

FIG. 4 is a perspective view of a nozzle assembly for a recirculating pressurized air loop, according to other embodiments.

FIG. 5 is a side view cross-section of a nozzle assembly for a recirculating pressurized air loop, according to some embodiments.

FIG. 6 is a flow diagram of a process for cleaning a surface by using a recirculating pressurized air loop, according to some embodiments.

### DETAILED DESCRIPTION

This disclosure describes a cleaning apparatus that integrates both vacuum suction and directed airflow into a single system. The apparatus utilizes a vacuum system to generate a negative pressure flow at a nozzle assembly while a portion of the vacuum's exhaust is directed back to the nozzle assembly as a pressurized air stream. This pressurized air stream is strategically oriented to dislodge foreign object debris (FOD) from surfaces and guide them into the vacuum flow. By balancing the negative pressure and the directed air stream, the system may loosen and efficiently capture contaminants by maintaining a net negative pressure at the nozzle assembly. This approach minimizes airborne particle redistribution, enhances FOD containment, and improves cleaning efficiency in environments where contamination control is important.

In some embodiments, a cleaning apparatus includes a vacuum system that is configured to generate a negative pressure flow at a vacuum portion of a nozzle assembly for removing FOD from a surface. The vacuum system produces an exhaust resulting from the negative pressure flow. The cleaning apparatus also includes an exhaust outlet positioned at the nozzle assembly and configured to direct at least a portion of the exhaust as a pressurized air stream. The pressurized air stream is oriented to dislodge the FOD from the surface and direct the FOD toward the negative pressure flow. The negative pressure flow and the pressurized air stream are balanced to maintain a net negative pressure at the nozzle assembly so as to provide the FOD with a net force of attraction into the vacuum portion of the nozzle assembly. The vacuum portion of the nozzle assembly and the exhaust outlet may be coaxially aligned so that the pressurized air stream is configured annularly around the negative pressure flow. The nozzle assembly may include a shroud surrounding the negative pressure flow and the pressurized air stream at the nozzle assembly.

The nozzle assembly may include a directional flow guide configured to at least partially control air flow dynamics of the negative pressure flow and the pressurized air stream. The vacuum system may include an exhaust flow regulator configured to tune a pressure balance between the negative pressure flow and the pressurized air stream. Also, in some implementations, the vacuum system may include a HEPA filter configured to capture at least a portion of the FOD that is pulled into the negative pressure flow.

In some implementations, the cleaning apparatus may also include a flow control valve configured to dynamically adjust relative pressure between the negative pressure flow and the pressurized air stream to maintain the net force of attraction into the vacuum portion of the nozzle assembly.

In various implementations, the nozzle assembly may include a sensor system for measuring airflow balance between the negative pressure flow and the pressurized air stream. The cleaning apparatus may also include an adjustable aperture located in the nozzle assembly and configured to control a ratio of the negative pressure flow to the pressurized air stream based on the measured airflow balance.

In some implementations, the cleaning apparatus may also include a sensor system configured to detect and count the FOD in the exhaust and automatically adjust the negative pressure flow and the pressurized air stream based on the detection or the count of the FOD.

In some implementations, the negative pressure flow and the pressurized air stream may be configured to create a vortex flow between the surface and the nozzle assembly.

In some embodiments, a recirculating pressurized air loop system for removing FOD from a surface may include an air pump to create recirculating pressurized air and a nozzle assembly that includes an uncontained portion of the recirculating pressurized air loop. The nozzle assembly may be configured to introduce the FOD into the recirculating pressurized air loop. The system may further include a vacuum line configured to contain the pressurized air flowing from the nozzle assembly to the air pump and an exhaust line configured to contain the pressurized air flowing from the air pump to the nozzle assembly.

In some implementations, the recirculating pressurized air loop system may further include a flow control valve configured to adjust relative pressure at the nozzle assembly between the vacuum line and the exhaust line, a sensor system configured to detect and count the FOD in the recirculating pressurized air loop and automatically adjust relative pressure at the nozzle assembly between the vacuum line and the exhaust line based on the detection or the count of the FOD, and/or a HEPA filter (or other type of air filter) in the exhaust portion and configured to capture at least a portion of the FOD that is introduced into the recirculating pressurized air loop.

In some embodiments, a method for cleaning a surface may include generating a vacuum intake airflow at a nozzle assembly to remove FOD from a surface, directing at least a portion of exhaust air from the vacuum intake airflow to an air discharge port that is positioned adjacent to the vacuum intake airflow, dislodging the FOD from the surface using the exhaust air while simultaneously capturing the FOD with the vacuum intake airflow, directing at least the portion of the exhaust air from the vacuum intake airflow through an air filter that is located before the air discharge port, and adjusting a balance between a flow of the exhaust air from the discharge port and the intake airflow so as to maintain a net negative air pressure at the nozzle assembly.

In some implementations, the method may further include detecting and/or counting the FOD in the exhaust air and automatically adjusting the vacuum intake airflow and the exhaust air based on the detection or the counting of the FOD, and/or dynamically operating a flow control valve to adjust relative pressure between the vacuum intake airflow and the exhaust air to maintain the net negative air pressure at the nozzle assembly.

The vacuum intake airflow at the nozzle assembly and the exhaust air from the air discharge port may be coaxially aligned so that the exhaust air is configured to flow annularly around the vacuum intake airflow. The nozzle assembly may include a shroud surrounding the vacuum intake airflow at the nozzle assembly and the exhaust air from the air discharge port.

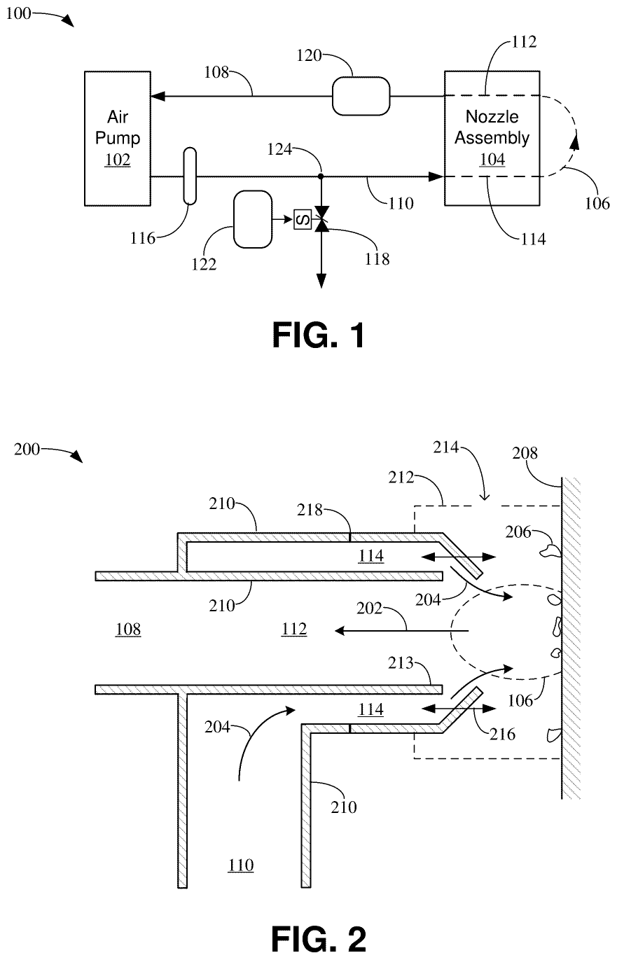

FIG. 1 is a block diagram of a recirculating pressurized air loop system 100 for removing FOD from a surface, according to some embodiments. System 100 may include an air pump 102 to create recirculating pressurized air and a nozzle assembly 104 that includes an uncontained portion 106 of the recirculating pressurized air loop. Herein, “uncontained” in this context means that air flowing inside the loop system, where it is contained within tubing or pipe walls, for example, is free to flow away from the loop system because there are no physical barriers (e.g., tube walls) for containment. As explained below, however, a net negative pressure, among other things, at uncontained portion 106 leads to the returning of released, uncontained air back into the recirculating pressurized air loop. In particular, at this point, nozzle assembly 104 may be configured to introduce FOD into the recirculating pressurized air loop via the uncontained air.

System 100 may further include a vacuum line 108 for containing air flow from nozzle assembly 104 to air pump 102, and an exhaust line 110 for containing air flow from the air pump to the nozzle assembly. Vacuum line 108 may provide a negative pressure (e.g., vacuum) to a vacuum portion 112 of nozzle assembly 104 and exhaust line 110 may provide a pressurized air stream to an exhaust port 114 of the nozzle assembly.

Air pump 102 may be configured to generate a negative pressure flow at vacuum portion 112 of nozzle assembly 104 while at least a portion of the exhaust of air pump 102 is directed back to the nozzle assembly as the pressurized air stream from exhaust port 114. Uncontained portion 106 may include air flow from exhaust port 114 to vacuum portion 112. This pressurized air stream from exhaust port 114 may be strategically oriented to dislodge FOD from surfaces that are at or near uncontained portion 106 of the recirculating pressurized air loop. Dislodged FOD may then be pulled into vacuum portion 112 of the nozzle assembly.

A particle filter 116, such as a HEPA filter, may be located in exhaust line 110 and configured to capture at least a portion of the FOD that is introduced into the recirculating pressurized air loop.

In some implementations, a flow path of nozzle assembly 104 may be provided externally with compressed air, GN₂ (gaseous nitrogen), or other gas to be used, for example, as an air-blade, wherein none of the vacuum exhaust (e.g., via 112) is recirculated back.

In some implementations, system 100 may further include a flow control valve 118 configured to adjust relative pressure at nozzle assembly 104 between vacuum portion 112 and exhaust port 114. A sensor system 120 may be configured to detect and count FOD in the recirculating pressurized air loop, such as in vacuum line 108 and/or exhaust line 110, and automatically adjust relative pressure at the nozzle assembly between vacuum portion 112 and exhaust port 114 based on the detection or the count of the FOD. For example, sensor system 120 may include a particle counter such as an optical particle sensor (e.g., laser or IR-based), which can detect airborne particulate matter using light scattering techniques. Another type of particle counter may be an electrostatic or triboelectric sensor, which can detect charged particles moving through the system. Claimed subject matter is not limited to any particular type of particle counter. A particle counter may be placed inside the air flow before or after filter 116 and/or near nozzle assembly 104. If the particle counter is located downstream from filter 116, particles escaping filtration may be detected. If the particle counter is located upstream from filter 116, particle count (e.g., FOD concentration) may represent a FOD intake rate, allowing real-time adjustments to airflow balance between the negative pressure flow of vacuum portion 112 and the pressurized air stream of exhaust port 114. By balancing the negative pressure and the directed air stream, the system may loosen and efficiently capture contaminants by maintaining a net negative pressure at the nozzle assembly. This approach minimizes airborne particle redistribution, enhances FOD containment, and improves cleaning efficiency in environments where contamination control is important. In particular, airflow balance may affect efficiency of dislodging particles from a surface being cleaned. For example, the efficiency of dislodging FOD from a surface during cleaning may be dependent on the balance between the negative pressure flow and the pressurized air stream. However, there is no universal airflow balance that is optimal for all types of FOD, as the adhesion mechanisms and surface properties can vary significantly. For instance, fine dust particles may adhere to surfaces due to electrostatic forces, while others may be held in place by Van der Waals interactions, surface tension, or mechanical interlocking with surface irregularities. The composition and texture of the surface itself, whether metal, plastic, or composite material, may further influence how FOD clings to it. Therefore, an adaptable system that can dynamically adjust the airflow balance based on the nature of the FOD and the characteristics of the surface being cleaned may be useful for achieving optimal debris removal.

A processor 122, which may be configured to received sensor data from sensor system 120, may operate flow control valve 118 to apply real-time adjustments to airflow balance between the negative pressure flow of vacuum portion 112 and the pressurized air stream of exhaust port 114. Flow control valve 118, depending on its setting, allows for removal at junction 124 of a portion of air flow in exhaust line 110.

FIG. 2 is a side view cross-section of a nozzle assembly 200 for a recirculating pressurized air loop, according to some embodiments. For example, nozzle assembly 200 may be the same as or similar to nozzle assembly 104. Accordingly, portions of vacuum line 108 and exhaust line 110 are illustrated. Vacuum line 108 provides a negative pressure flow 202 of vacuum portion 112 and exhaust line 110 provides a pressurized air stream 204 of exhaust port 114.

Uncontained portion 106, which includes air flow from exhaust port 114 to vacuum portion 112, is approximately indicated by a dashed oval. This pressurized air stream flow from exhaust port 114 may be strategically oriented to dislodge FOD 206 from a surface 208 that is at or near uncontained portion 106. Dislodged FOD may then be pulled into vacuum portion 112 by negative pressure flow 202.

In various implementations, vacuum portion 112 may concentrically positioned within exhaust portion 114, helping to ensure that dislodged FOD may be immediately captured by negative pressure flow 202. For example, such a concentric design may enhance the efficiency of debris collection while minimizing unwanted dispersal of contaminants.

Nozzle assembly 200 may be constructed from various materials, depending on the operational environment and cleaning requirements. For example, walls 210 may be lightweight polymers and may be used for applications where maneuverability is important, while heat-resistant metals may be preferred for industrial or aerospace environments where high-temperature conditions are a factor. Additionally, anti-static coatings 213 may be applied to prevent electrostatic adhesion of fine particulate matter. The selection of materials and structural configuration may be tailored to optimize cleaning performance for different types of FOD and surface materials, though claimed subject matter is not limited in this respect.

Nozzle assembly 200 may include a shroud 212, approximately indicated by dashed lines, that surrounds both negative pressure flow 202 at vacuum portion 112 and exhaust port 114. Shroud 212 may serve multiple purposes, including controlling the interaction between the pressurized air stream and the negative pressure flow, minimizing unwanted air turbulence, and enhancing the efficiency of FOD removal. By enclosing vacuum portion 112 and exhaust port 114, shroud 212 may help to maintain a controlled airflow environment, reducing the escape of dislodged debris and preventing cross-contamination in sensitive environments, such as clean rooms or aerospace applications. For example, shroud 212 may help prevent disruption of surrounding air columns, which may be especially important in controlled environments where particulate matter is to be confined to avoid contamination. By guiding both the pressurized air stream and the vacuum suction within a defined space, nozzle assembly 200 with shroud 212 helps to ensure that FOD is effectively dislodged and immediately captured without being dispersed back into the environment.

The design of shroud 212 may be tailored to accommodate different operational needs. For example, shroud 212 may feature adjustable vents or openings 214 to fine-tune airflow balance based on the type of FOD being removed. The material selection for the shroud may also vary, depending on durability, weight, and environmental considerations. Shroud 212 may be constructed from rigid materials such as metal alloys for industrial use or flexible, lightweight polymers for handheld or portable applications. For example, shroud 212 may be a flexible material so that contact with surface 208 need not result in scuffing or other degradation of surface 208, for example. Additionally, shroud 212 may incorporate anti-static or dust-repellent coatings to prevent particle adhesion, ensuring continuous efficiency during prolonged operation.

In some implementations, nozzle assembly 200 may include an adjustable aperture, as schematically indicated by arrows 216, designed to control the ratio of negative pressure flow 202 to the pressurized air stream 204. This feature enables dynamic tuning of airflow balance, allowing the system to optimize FOD removal based on real-time conditions. The adjustable aperture may be mechanically or electronically controlled, enabling precision adjustments to accommodate different types of debris and surface adhesion mechanisms. Herein, the adjustable aperture is considered to be the opening of the exhaust port 114 to uncontained portion 106, the opening of the vacuum portion 112 to uncontained portion 106, both, or one relative to the other.

By modulating the adjustable aperture, the system (e.g., 100) can alter the relative strengths and flow directions of suction and blowing forces, ensuring that the pressurized air stream effectively dislodges FOD without dispersing it beyond the reach of the vacuum portion. This adaptability may be particularly useful for addressing various types of debris, including electrostatically adhered dust, Van der Waals force-bound particles, or heavier contaminants requiring a stronger suction force.

In some implementations, the adjustable aperture may be sensor-driven, with an airflow monitoring system (e.g., sensor system 120) that can detect changes in airflow resistance, debris accumulation, or environmental factors. The adjustable aperture may then be automatically adjusted in response to such variables, allowing for continuous optimization of cleaning performance. Alternatively, a manual adjustment mechanism, such as a dial or sliding control, may allow an operator to fine-tune the airflow balance based on visual feedback or operational experience. In either case, a sliding (e.g., telescoping) junction 218, for example, may allow for the adjustable aperture to be mechanically adjusted. The location of the adjustable aperture within nozzle assembly 200 may also enhance efficiency. The adjustable aperture may be positioned near the junction of exhaust port 114 and vacuum portion 112, allowing fine control over the interplay between suction and blowing forces.

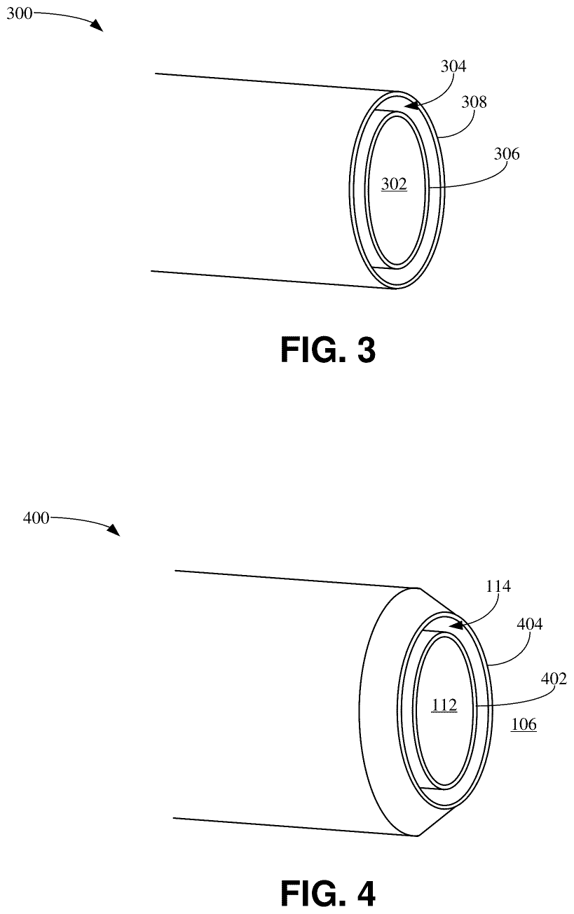

FIG. 3 is a perspective view of a nozzle assembly 300 for a recirculating pressurized air loop, according to some embodiments. For example, nozzle assembly 300 may be the same as or similar to nozzle assembly 104. Nozzle assembly 300 may include a vacuum portion 302 and an exhaust port 304. In the illustrated coaxial configuration, a wall 306 may separate vacuum portion 302 and exhaust port 304, while an outer wall 308 contains the whole nozzle assembly 300.

FIG. 4 is a perspective view of a nozzle assembly 400 for a recirculating pressurized air loop, according to other embodiments. For example, nozzle assembly 400 may be the same as or similar to nozzle assembly 104 or 200. Accordingly, vacuum portion 112 and exhaust port 114 are illustrated. In a coaxial configuration, a wall 402 (e.g., 210) may separate vacuum portion 112 and exhaust port 114, while an outer wall 404 (e.g., 210) contains the whole nozzle assembly 400.

In some implementations, an adjustable aperture is located at or near the junction between exhaust port 114 and vacuum portion 112 at the open end of the nozzle assembly. This adjustable aperture, indicated by arrows 216 in FIG. 2, may be designed to regulate the ratio between negative pressure flow 202 (suction) and pressurized air stream 204 (blowing), as mentioned above. In various implementations, the adjustable aperture may refer to i) the opening of exhaust port 114 to uncontained portion 106, ii) the opening of vacuum portion 112 to uncontained portion 106, or iii) both openings in relation to each other, allowing for relative adjustment.

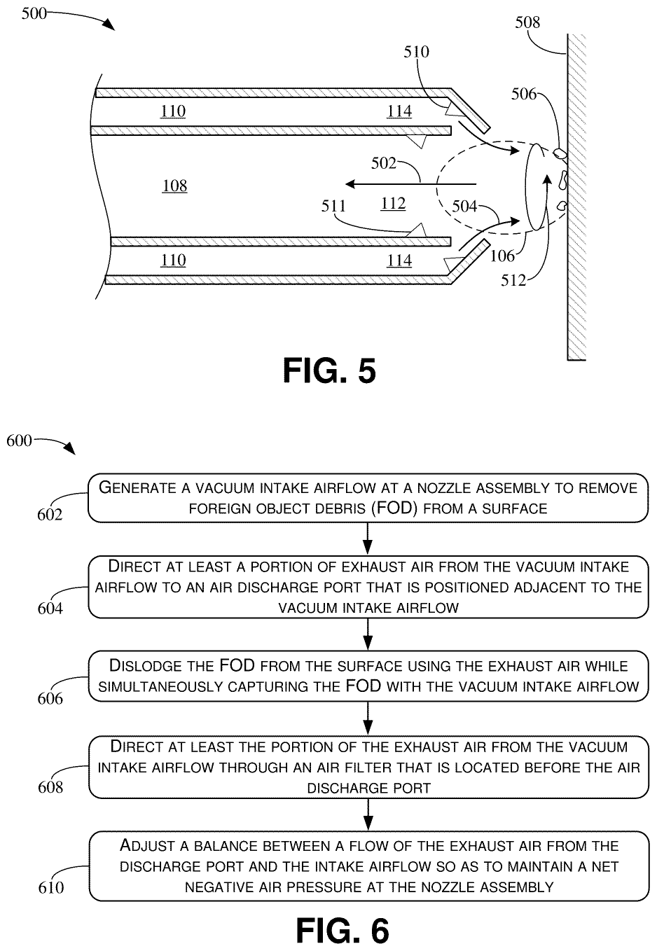

FIG. 5 is a side view cross-section of a nozzle assembly 500 for a recirculating pressurized air loop, according to some embodiments. For example, nozzle assembly 500 may be the same as or similar to nozzle assemblies 104 or 200 with the addition of some features. Accordingly, portions of vacuum line 108 and exhaust line 110 are illustrated. Vacuum line 108 may provide a negative pressure flow 502 of vacuum portion 112 and exhaust line 110 may provide a pressurized air stream 504 of exhaust port 114.

Uncontained portion 106, which includes air flow (e.g., 504) from exhaust port 114 to vacuum portion 112, is approximately indicated by a dashed oval, as in FIG. 2. This pressurized air stream flow from exhaust port 114 may be strategically oriented to dislodge FOD 506 from a surface 508 that is at or near uncontained portion 106. Dislodged FOD may then be pulled into vacuum portion 112 by negative pressure flow 502. Nozzle assembly 500 may include fins or guides 510 located in exhaust port 114. In some implementations, fins or guides 510 may be configured to guide pressurized air stream 504 from exhaust port 114 into a vortex flow 512 within uncontained portion 106. For example, instead of directing the air in a purely linear fashion, the vortex flow introduces a swirling motion that may enhance the removal of FOD from surface 508. By applying rotational energy to the airflow, the system can increase surface agitation, helping to loosen debris that may be electrostatically adhered, bound by Van der Waals forces, or held in place due to surface roughness, for example. In some implementations, nozzle assembly 500 may also include fins or guides 511 located in negative pressure flow 502 of vacuum portion 112.

Vortex flow 512 may also help to prevent dislodged FOD from resettling on surface 508 by guiding the FOD toward vacuum portion 112, where it can be removed by negative pressure flow 502. This swirling motion may help to ensure that loosened debris remains within the influence of the vacuum system rather than dispersing unpredictably.

FIG. 6 is a flow diagram of a process 600 for cleaning a surface by using a recirculating pressurized air loop, such as that of system 100, according to some embodiments. Process 600 may be performed by an operator (e.g., a person), a robotic system, or an automated control mechanism. In some cases, a computer processing system (e.g., processor 122), following preprogrammed or sensor-based instructions may at least partially control process 600, adjusting airflow dynamically based on detected conditions, for example.

At 602, the operator may generate a vacuum intake airflow at a nozzle assembly to remove FOD from a surface. This vacuum intake airflow creates a negative pressure region at a nozzle opening of the nozzle assembly, drawing in debris that have been loosened or dislodged. The vacuum strength may be adjustable, allowing for control based on the type of surface being cleaned and the adhesion properties of the FOD. The negative pressure helps to ensure that dislodged particles are not merely scattered but are effectively captured and contained.

At 604, the operator may direct at least a portion of exhaust air from the vacuum intake airflow to an air discharge port that is positioned adjacent to the vacuum intake airflow. The air discharge port is positioned to direct the airflow back toward the cleaning area, helping to ensure that loosened FOD is pushed into the path of the vacuum intake rather than being dispersed into the surrounding environment. At 606, the operator may dislodge the FOD from the surface using the exhaust air while simultaneously capturing the FOD with the vacuum intake airflow. The exhaust air may be used as a controlled pressurized air stream, which helps to loosen particles that are adhered due to electrostatic forces, Van der Waals interactions, or surface contamination. The dual-action process, combining directed airflow with simultaneous suction, helps to prevent debris from escaping the controlled airflow region, reducing contamination risks in cleanroom environments or other sensitive areas.

At 608, the operator may direct at least the portion of the exhaust air from the vacuum intake airflow through an air filter that is located before the air discharge port. This filtering step helps to ensure that fine particulates, contaminants, or hazardous materials do not re-enter the surrounding air environment when the exhaust air is discharged. The filter may be a HEPA filter or another high-efficiency filtration system designed to trap microscopic debris while allowing for sufficient airflow to maintain effective pressurization

At 610, the operator may adjust a balance between a flow of the exhaust air from the discharge port and the intake airflow so as to maintain a net negative air pressure at the nozzle assembly. This step helps to ensure that airborne debris remains contained rather than being spread. The balance may be controlled manually through mechanical adjustments, such as an adjustable aperture, or automatically through a sensor-driven feedback system that dynamically modifies airflow based on real-time measurements. The ability to tune the airflow balance may allow for adaptability across different cleaning conditions, surface types, and FOD characteristics.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A cleaning apparatus comprising:
a vacuum system configured to generate a negative pressure flow at a vacuum portion of a nozzle assembly for removing foreign object debris (FOD) from a surface, wherein the vacuum system produces an exhaust resulting from the negative pressure flow; and
an exhaust outlet positioned at the nozzle assembly and configured to direct at least a portion of the exhaust as a pressurized air stream, wherein the pressurized air stream is oriented to dislodge the FOD from the surface and direct the FOD toward the negative pressure flow, wherein the negative pressure flow and the pressurized air stream are balanced to maintain a net negative pressure at the nozzle assembly so as to provide the FOD with a net force of attraction into the vacuum portion of the nozzle assembly.

2. The cleaning apparatus of claim 1, wherein the vacuum portion of the nozzle assembly and the exhaust outlet are coaxially aligned so that the pressurized air stream is configured annularly around the negative pressure flow.

3. The cleaning apparatus of claim 1, wherein the nozzle assembly includes a shroud surrounding at least the negative pressure flow at the vacuum portion of the nozzle assembly and the exhaust outlet.

4. The cleaning apparatus of claim 1, further comprising a flow control valve configured to dynamically adjust relative pressure between the negative pressure flow and the pressurized air stream to maintain the net force of attraction into the vacuum portion of the nozzle assembly.

5. The cleaning apparatus of claim 1, wherein the nozzle assembly includes a sensor system for measuring airflow balance between the negative pressure flow and the pressurized air stream.

6. The cleaning apparatus of claim 5, further comprising an adjustable aperture located in the nozzle assembly and configured to control a ratio of the negative pressure flow to the pressurized air stream based on the measured airflow balance.

7. The cleaning apparatus of claim 1, further comprising a sensor system configured to detect and count the FOD in the exhaust and automatically adjust the negative pressure flow and the pressurized air stream based on the detection or the count of the FOD.

8. The cleaning apparatus of claim 1, wherein the nozzle assembly includes a directional flow guide configured to at least partially control airflow dynamics of the negative pressure flow and the pressurized air stream.

9. The cleaning apparatus of claim 1, wherein the vacuum system comprises an exhaust flow regulator configured to tune a pressure balance between the negative pressure flow and the pressurized air stream.

10. The cleaning apparatus of claim 1, wherein the vacuum system comprises a HEPA filter configured to capture at least a portion of the FOD that is pulled into the negative pressure flow.

11. The cleaning apparatus of claim 1, wherein the negative pressure flow and the pressurized air stream are configured to create a vortex flow between the surface and the nozzle assembly.

12. A recirculating pressurized air loop system for removing foreign object debris (FOD) from a surface, the recirculating pressurized air loop system comprising:
an air pump to create recirculating pressurized air;
a nozzle assembly that includes an uncontained portion of the recirculating pressurized air loop, wherein the nozzle assembly is configured to introduce the FOD into the recirculating pressurized air loop;
a vacuum line configured to contain the pressurized air flowing from the nozzle assembly to the air pump; and
an exhaust line configured to contain the pressurized air flowing from the air pump to the nozzle assembly.

13. The system of claim 12, further comprising a flow control valve configured to adjust relative pressure at the nozzle assembly between the vacuum line and the exhaust line.

14. The system of claim 12, further comprising a sensor system configured to detect and count the FOD in the recirculating pressurized air loop and automatically adjust relative pressure at the nozzle assembly between the vacuum line and the exhaust line based on the detection or the count of the FOD.

15. The system of claim 12, further comprising a HEPA filter in the exhaust line and configured to capture at least a portion of the FOD that is introduced into the recirculating pressurized air loop.

16. A method for cleaning a surface, the method comprising:
generating a vacuum intake airflow at a nozzle assembly to remove foreign object debris (FOD) from a surface;
directing at least a portion of exhaust air from the vacuum intake airflow to an air discharge port that is positioned adjacent to the vacuum intake airflow;
dislodging the FOD from the surface using the exhaust air while simultaneously capturing the FOD with the vacuum intake airflow;
directing at least the portion of the exhaust air from the vacuum intake airflow through an air filter that is located before the air discharge port; and
adjusting a balance between a flow of the exhaust air from the discharge port and the intake airflow so as to maintain a net negative air pressure at the nozzle assembly.

17. The method of claim 16, further comprising detecting and counting the FOD in the exhaust air and automatically adjusting the vacuum intake airflow and the exhaust air based on the detection or the counting of the FOD.

18. The method of claim 16, further comprising dynamically operating a flow control valve to adjust relative pressure between the vacuum intake airflow and the exhaust air to maintain the net negative air pressure at the nozzle assembly.

19. The method of claim 16, wherein the vacuum intake airflow at the nozzle assembly and the exhaust air from the air discharge port are coaxially aligned so that the exhaust air is configured to flow annularly around the vacuum intake airflow.

20. The method of claim 16, wherein the nozzle assembly includes a shroud surrounding the vacuum intake airflow at the nozzle assembly and the exhaust air from the air discharge port.
